(19) United States
(12) Patent Application Publication
(10) Pub. No.: US 2007/0245746 A1
(43) Pub. Date: Oct. 25, 2007

(54) Methods and systems for detecting rotor assembly speed oscillation in turbine engines

(76) Inventors: Daniel E. Mollmann, Cincinnati, OH (US); Gert J. van der Merwe, Monroe, OH (US); Lawrence Joseph Bach, Cincinnati, OH (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(21) Appl. No.: 11/408,639

(22) Filed: Apr. 21, 2006

(51) Int. Cl. F02C 7/00

(52) U.S. Cl. 60/779; 60/39.282

(57) ABSTRACT

A method for operating a gas turbine engine is provided. The method comprises coupling at least one sensor within the gas turbine engine to transmit a signal indicative of a rotational speed of a rotor assembly within the gas turbine engine, detecting oscillations of the rotor assembly based on the signal transmitted from the at least one sensor, comparing detected oscillations to a predetermined oscillation threshold, and generate an output to facilitate fuel flow adjustments during non-engine operational periods, wherein the fuel flow adjustments facilitate reducing oscillations of the rotor assembly during engine operation.

### BACKGROUND OF THE INVENTION

This invention relates generally to turbine engines and more particularly, to methods and systems for detecting rotor assembly speed oscillation in turbine engines.

At least some known gas turbine engines used with aircraft include a forward fan assembly and a core engine that is downstream from the fan assembly. The core engine includes at least one compressor, a combustor, a high-pressure turbine and a low-pressure turbine coupled together in a serial flow relationship. More specifically, the compressor and high-pressure turbine are coupled through a shaft to define a high-pressure rotor assembly, and the low pressure turbine and the fan assembly are coupled together. Air entering the core engine is mixed with fuel injected into the combustor and is ignited to form a high energy gas stream. The high energy gas stream flows through the high-pressure turbine to rotatably drive the high-pressure turbine such that the shaft, in turn, rotatably drives the compressor.

Variances in the fuel supply pressure to the gas turbine engine may cause fan speed and/or engine thrust to modulate in amplitude. Specifically, a variance in the fuel supply pressure may cause a modulation in fuel flow to the combustor, which in turn modulates thrust and associated airflows and pressures within the engine. For low amplitude modulations, the effects of the variance are generally minor and may induce vibrations to the associated aircraft. However, if the amplitude modulation is high enough, the modulation may induce potentially damaging structural stresses to the engine. For example, the rotor shaft coupling the low-pressure turbine to the fan assembly may be susceptible to structural failures because it is excited by the airflow/pressure modulation passing through the low-pressure turbine.

Currently, known methods to detect such modulations rely on human detection of airframe vibration and/or a dedicated data system to detect and quantify the response. However, human detection of such modulations is generally unreliable and does not provide an accurate means of quantifying the response, and known data systems increase the overall weight, complexity, and costs associated with the engine. Moreover, none of the engine monitoring systems accurately detect fuel flow modulations unless the amplitude is large and already generating potentially damaging stresses.

### BRIEF SUMMARY OF THE INVENTION

In one aspect, a method for operating a gas turbine engine is provided. The method comprises coupling at least one sensor within the gas turbine engine to transmit a signal indicative of a rotational speed of a rotor assembly within the gas turbine engine, detecting oscillations of the rotor assembly based on the signal transmitted from the at least one sensor, comparing detected oscillations to a predetermined oscillation threshold, and generate an output to facilitate fuel flow adjustments during non-engine operational periods, wherein the fuel flow adjustments facilitate reducing oscillations of the rotor assembly during engine operation.

In another aspect, a control system for a turbine engine including a combustor is provided. The control system includes at least one sensor and an engine monitoring unit (EMU) coupled to the at least one sensor for receiving a signal transmitted therefrom. The at least one sensor is configured to transmit a signal indicative of the rotational speed of a rotor assembly within the gas turbine engine. The EMU is configured to detect oscillations of the rotor assembly based on the signal received from said at least one sensor, and the EMU is further configured to generate an output if oscillations of the rotor assembly exceed a pre-determined threshold.

In a further aspect, a gas turbine engine control system is provided. The gas turbine engine control system includes at least one sensor configured to transmit a signal, during engine operation, indicative of the rotational speed of a rotor assembly within the gas turbine engine, and an engine monitoring unit (EMU) coupled to the at least one sensor and to a fuel control system. The EMU includes a processor programmed to detect oscillations of the rotor assembly, during rotor operation, based on the signal transmitted from the at least one sensor, and to generate an output if detected oscillations exceed a pre-determined oscillation threshold, to facilitate fuel flow control adjustments that facilitate reducing oscillations of the rotor assembly.

### BRIEF DESCRIPTION OF THE DRAWINGS

FIG. 1 is a perspective view of an exemplary aircraft;

FIG. 2 is a schematic illustration of an exemplary gas turbine engine that may be used with the aircraft shown in FIG. 1;

FIG. 3 illustrates an exemplary frequency and amplitude modulation of a pulse train that may be detected during operation of the gas turbine engine shown in FIG. 3; and

FIG. 4 is flowchart illustrating an exemplary method of reducing fan speed oscillation within the gas turbine engine shown in FIG. 2.

### DETAILED DESCRIPTION OF THE INVENTION

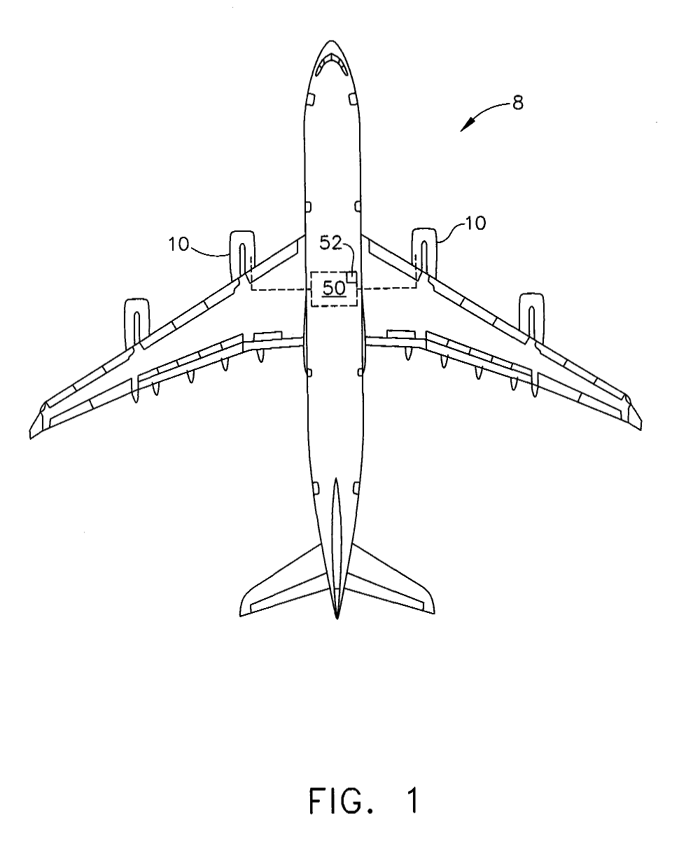

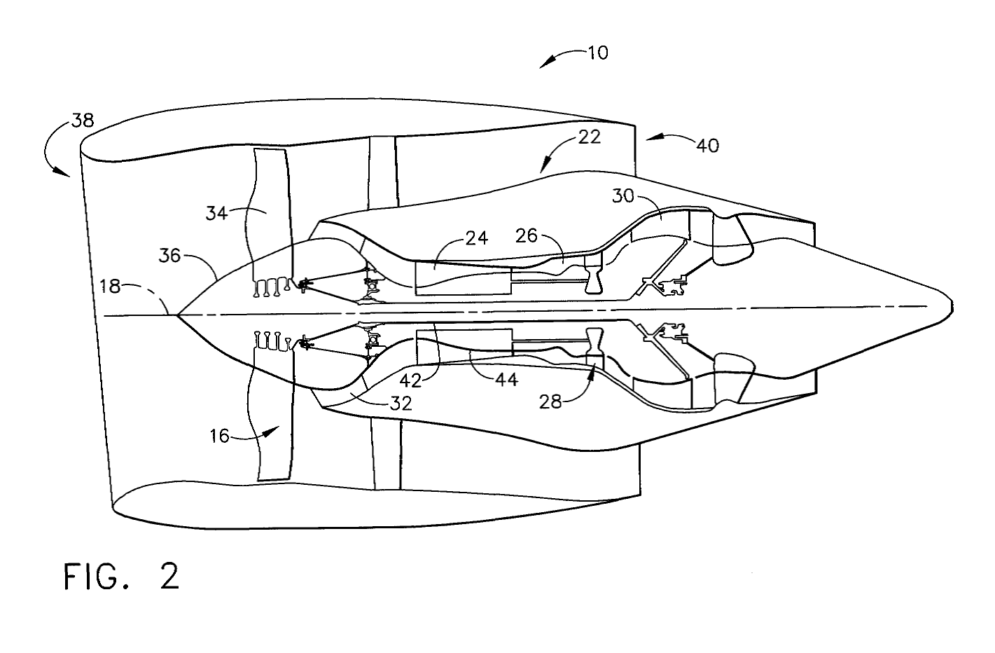

FIG. 1 is a schematic illustration of an exemplary aircraft 8 that includes at least one exemplary gas turbine engine 10 that is installed on aircraft 8. FIG. 2 is a schematic illustration of gas turbine engine 10. In the exemplary embodiment, gas turbine engine 10 includes a fan assembly 16 disposed about a longitudinal centerline axis 18. Gas turbine engine 10 also includes a core gas turbine engine 22 that includes a high pressure compressor 24, a combustor 26, and a high pressure turbine 28. In the exemplary embodiment, gas turbine engine 10 also includes a low pressure turbine 30 and a multi-stage booster compressor 32.

Fan assembly 12 includes an array of fan blades 34 extending radially outward from a rotor disk 36. Engine 10 has an intake side 38 and an exhaust side 40. In the exemplary embodiment, gas turbine engine 10 is a GE90 gas turbine engine that is available from General Electric Company, Cincinnati, Ohio. Fan assembly 16, booster 32, and low-pressure turbine 30 are coupled together by a first rotor shaft 42, and compressor 24 and high-pressure turbine 28 are coupled together by a second rotor shaft 44.

In operation, air flows through fan assembly 12 and compressed air is supplied to high pressure compressor 24 through booster 32. The booster discharge air is channeled to compressor 24 wherein the airflow is further compressed and delivered to combustor 26. Fuel is injected to combustor 26 wherein the fuel is mixed with air and the mixture is ignited. Hot products of combustion from combustor 26 generate thrust from aircraft 8 and are utilized to drive turbines 28 and 30, and rotation of turbine 30 drives fan assembly 16 and booster 32 by way of shaft 42. Engine 10 is operable at a range of operating conditions between design operating conditions and off-design operating conditions.

In the exemplary embodiment, engine 10 includes an engine control system 50 that facilitates controlling operation of engine 10. Engine control system 50 includes an electronic control unit (ECU) or an engine monitoring unit (EMU) 52 such as a Full Authority Digital Engine Control (FADEC), or a Modernized Digital Engine Control (MDEC). In an alternative embodiment, engine control system 50 includes any engine controller that is configured to send and/or receive signals from gas turbine engine 10 to facilitate control and/or monitoring of engine 10. Specifically, as used herein, an ECU can be any electronic device that resides on or around an engine and includes a processor and at least one of software and/or hardware that is programmed to control and/or monitor gas turbine engine 10. More specifically, in the exemplary embodiment, as described in more detail below, control unit 52 generates engine control signals based on the measured values supplied by the sensors.

As defined herein, the term “processor” may include any programmable system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “processor”

Conventional engine data sensors (not shown) and aircraft data sensors (not shown) are provided to sense selected data parameters related to the operation of gas turbine engine 10 and aircraft 8. The invention utilizes a pulse train detected and transmitted by a sensor to the ECU 52. In the exemplary embodiment, such data parameters can include, but are not limited to, aircraft parameters such as altitude, ambient temperature, ambient pressure and air speed, and engine parameters such as exhaust gas temperature, oil temperature, engine fuel flow, core gas turbine engine speed, compressor discharge pressure, turbine exhaust pressure, fan speed, and/or a plurality of other signals received from gas turbine engine 10, for example. The ECU 52 receives signals from the engine and aircraft data sensors 40. The ECU 52 also receives a thrust request signal from a throttle controlled by the aircraft's pilot.

Additionally, although the herein described methods and apparatus are described in an aircraft setting, it is contemplated that the benefits of the invention accrue to those systems typically employed in an industrial setting such as, for example, but not limited to, power plants. Accordingly, and in the exemplary embodiment, gas turbine engine 10 and engine control system 50 are coupled to a vehicle such as aircraft 8, such that information collected by system 50 is either stored in ECU 52 on aircraft 8, or alternatively, the information is transmitted to a ground facility and downloaded onto a local computer (not shown). In an alternative embodiment, gas turbine engine 10 and system 50 are installed in a ground facility such as a power plant, for example.

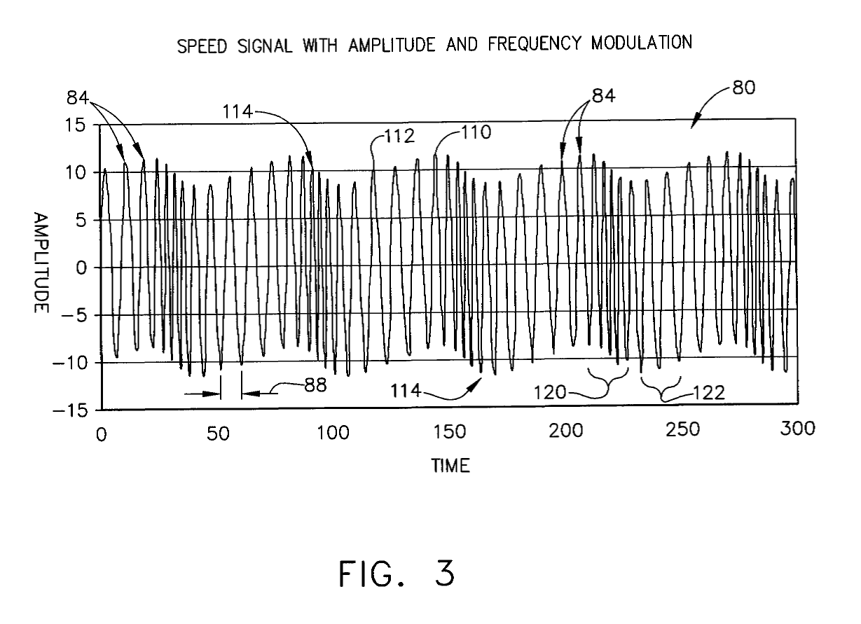

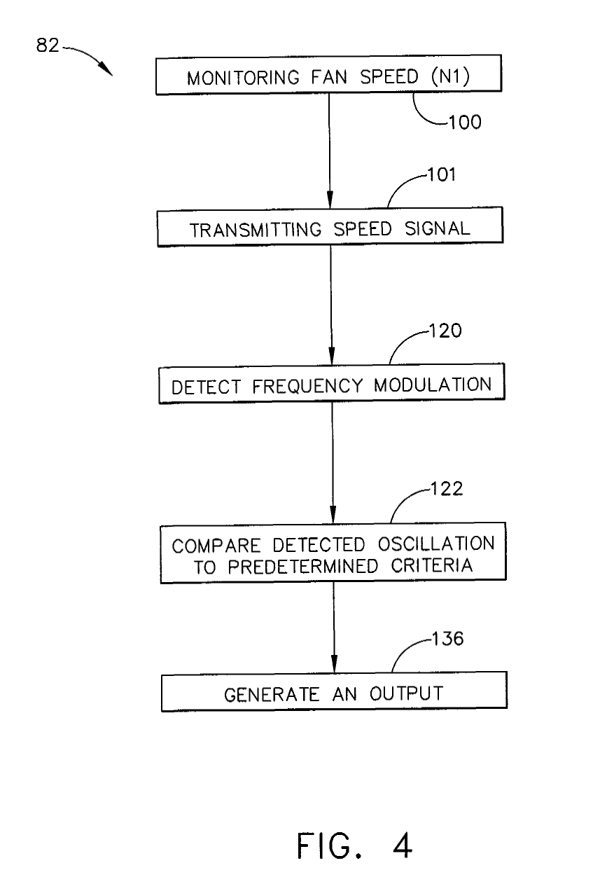

FIG. 3 illustrates an exemplary frequency and amplitude modulation of a pulse train 80 that may be detected during operation of gas turbine engine 10. FIG. 4 is flowchart illustrating an exemplary method 82 of reducing fan speed oscillation, i.e., undesirable acceleration or slowing of the fan rotational speed, within gas turbine engine 10. As described above, engine 10 includes a plurality of sensors coupled to engine control system 50 (shown in FIG. 2). In the exemplary embodiment, the sensors include, but are not limited to including, a fan speed sensor (N1). Such sensors are well known in the art and may be, but is not limited to being, a reluctance sensor, a Hall Effect sensor, an optical proximity sensors, and/or a microwave proximity sensor. Generally, the present methods and systems are directed towards reducing the oscillation of a rotating member, such as fan assembly 12.

The method 82 includes the step of monitoring 100 the fan speed (N1) and transmitting 101 a signal representative of fan speed to the engine control unit 50. During monitoring, as is known in the art, the sensor produces pulse train 80 in response to rotation of fan assembly 12. In an ideal case in which no oscillations or vibrations are occurring, pulses 84 within pulse train 80 will be substantially identical in shape, and time intervals 88 between adjacent pulses 84 will also be substantially identical if fan assembly 12 is rotated at a constant speed.

However, fuel flow modulations can occur such that the ideal case will no longer exist. Fuel flow modulations can adversely affect pulse train 82. For example, as shown in FIG. 4, amplitude modulation can occur wherein an amplitude at a peak or point 110, for example, for a pulse 84 is larger than at a peak or point 112, for example. Fuel flow modulation can also cause oscillations 114 of the fan assembly 12 wherein the frequency is higher, i.e., a smaller time period 88 between adjacent pulses 82, during a first time period 120 than during a second period 121.

As such, during monitoring 100 of fan speed (N1), a signal representative of fan speed is transmitted 101 to the engine control unit 52. ECU 52 will determine the N1 fan speed and will detect 120 if the associated pulse train 82, contains frequency modulation 114. Such frequency modulation 114 is indicative of fan speed oscillation induced by fuel flow modulation.

More specifically, in the exemplary embodiment, ECU 52 may be programmed to detect 120 fan speed oscillation in a variety of methods. For example, in one embodiment, the time interval 88 between adjacent zero crossings 130 of the fan speed signal is analyzed to detect 120 fan speed oscillation. In another embodiment, the time period 88 between the peaks, i.e., 110 or 112, of adjacent pulses 84 is analyzed to detect 120 fan speed oscillation. In a further embodiment, a Fourier analysis of the fan speed signal is performed to quantify the frequency content. In yet another embodiment, an analog frequency-to-voltage converter (not shown) is used to extract the amplitude of the modulation in fan speed. In yet a further embodiment, a band pass filter (not shown), analog or digital, is used to extract the amplitude of the modulation in fan speed. In another embodiment, ECU 52 is programmed to perform any combination of the above-described detection methods.

In each embodiment, any detected oscillation 114 will be compared 122 to predetermined oscillation criteria stored in the processor. In the exemplary embodiment, if the detected oscillation 114 exceeds the predetermined criteria, ECU 52 generates 136 an output indicative of an unacceptable fan speed oscillation. For example, a warning signal can be transmitted to the cockpit of an aircraft, or stored in a maintenance log within the engine control system 50 if detected fan speed oscillation exceeds a predetermined limit. Alternately, numerical values indicating the amount of frequency modulation, can be displayed to an operator, such as a pilot.

Generally, when an output indicative of an unacceptable fan speed oscillation has been generated 136, during non-engine operational periods either the engine control system 50 may be replaced, or alternatively, maintenance and or adjustments to components, such as ECU 52, within system 50 may be made to modify, i.e., changing engine control logic, fuel flow to the gas turbine combustor to facilitate reducing fan speed oscillations during engine operation. In other embodiments, depending on the magnitude of fan speed oscillations, other, more complex, approaches can be undertaken upon detection 120 of the oscillations.

In each embodiment, the above-described engine control system provides a diagnostic means by which fan speed oscillation may be accurately detected and quantified. More specifically, the above-described engine control system provides a diagnostic means whereby rotor assembly oscillations using existing monitoring systems that have been programmed to detect the oscillations. As such, using the methods and systems described herein facilitates the earlier detection, and the detection of smaller oscillations, than is available using known detection methods. As such, during non-engine operational periods, the engine control system may be modified to enhance fuel flow control to the combustor that facilitate reducing fuel flow modulation to the combustor such that fan speed oscillation during engine operation is also reduced. As a result, a useful life of the engine may be facilitated to be enhanced as less structural stresses are induced to the engine as a result of fan speed oscillation.

Exemplary embodiments of engine control systems and turbine engines are described above in detail. The control systems and the turbine engines are not limited to use with the specific nozzle embodiments described herein, but rather, the control systems can be utilized independently and separately from other turbine engine components described herein. Moreover, the invention is not limited to the embodiments of the turbine engines described above in detail. Rather, other turbine engines may be utilized within the spirit and scope of the claims.

While the invention has been described in terms of various specific embodiments, those skilled in the art will recognize that the invention can be practiced with modification within the spirit and scope of the claims.

What is claimed is:

1. A method for operating a gas turbine engine, said method comprising:
coupling at least one sensor within the gas turbine engine to transmit a signal indicative of a rotational speed of a rotor assembly within the gas turbine engine;
detecting oscillations of the rotor assembly based on the signal transmitted from the at least one sensor;
comparing detected oscillations to a predetermined oscillation threshold; and
generating an output to facilitate fuel flow adjustments during non-engine operational periods, wherein the fuel flow adjustments facilitate reducing oscillations of the rotor assembly during engine operation.

2. A method in accordance with claim 1 wherein said detecting oscillations of the rotor assembly further comprises one of:
determining an amount of elapsed time between at least one of zero crossings of the signal received from said at least one sensor, and
determining an amount of elapsed time between adjacent peaks of the signal received from said at least one sensor.

3. A method in accordance with claim 1 wherein said detecting oscillations of the rotor assembly further comprises:
performing a Fourier analysis of the signal transmitted from the at least one signal; and
quantifying the frequency content of the signal received from said at least one sensor based on the Fourier analysis.

4. A method in accordance with claim 1 wherein said detecting oscillations of the rotor assembly further comprises determining the amplitude of the modulation in speed using an analog frequency-to-voltage converter.

5. A method in accordance with claim 1 wherein said detecting oscillations of the rotor assembly further comprises determining the amplitude of the modulation in speed using a band pass filter.

6. A control system for a turbine engine including a combustor, said control system comprising:
at least one sensor configured to transmit a signal indicative of the rotational speed of a rotor assembly within the gas turbine engine; and
an engine monitoring unit (EMU) coupled to said at least one sensor for receiving the signal transmitted therefrom, said EMU configured to detect oscillations of the rotor assembly based on the signal received from said at least one sensor, said EMU further configured to generate an output if oscillations of the rotor assembly exceed a pre-determined threshold.

7. A control system in accordance with claim 6 wherein said EMU is adjustable, based on the oscillation comparison, during non-engine operational periods to facilitate reducing oscillations of the rotor assembly during engine operation.

8. A control system in accordance with claim 6 wherein to detect oscillations of the rotor assembly, said EMU is further configured to determine an amount of elapsed time between zero crossings of the signal received from said at least one sensor.

9. A control system in accordance with claim 6 wherein to detect oscillations of the rotor assembly, said EMU is further configured to determine an amount of elapsed time between adjacent peaks of the signal received from said at least one sensor.

10. A control system in accordance with claim 6 wherein to detect oscillations of the rotor assembly, said EMU is further configured to quantify the frequency content of the signal received from said at least one sensor.

11. A control system in accordance with claim 10 wherein to quantify the frequency content of the signal received from said at least one sensor, said EMU is further configured to perform a Fourier analysis of the signal received from said at least one sensor.

12. A control system in accordance with claim 6 wherein to detect oscillations of the rotor assembly, said EMU is further configured to determine the amplitude of the modulation in speed using an analog frequency-to-voltage converter.

13. A control system in accordance with claim 6 wherein to detect oscillations of the rotor assembly, said EMU is further configured to determine the amplitude of the modulation in speed using a band pass filter.

14. A gas turbine engine control system comprising:
at least one sensor configured to transmit a signal, during engine operation, indicative of the rotational speed of a rotor assembly within the gas turbine engine;
an engine monitoring unit (EMU) coupled to said at least one sensor and to a fuel control system, said EMU comprising a processor programmed to:
detect oscillations of the rotor assembly, during rotor operation, based on the signal transmitted from said at least one sensor; and
generate an output if detected oscillations exceed a pre-determined oscillation threshold, to facilitate fuel flow control adjustments that facilitate reducing oscillations of the rotor assembly.

15. A gas turbine engine control system in accordance with claim 14 wherein to detect oscillations of the rotor assembly, said EMU is further programmed to determine an amount of elapsed time between zero crossings of the signal received from said at least one sensor.

16. A gas turbine engine control system in accordance with claim 14 wherein to detect oscillations of the rotor assembly, said EMU is further programmed to determine an amount of elapsed time between adjacent peaks of the signal received from said at least one sensor.

17. A gas turbine engine control system in accordance with claim 14 wherein to detect oscillations of the rotor assembly, said EMU is further programmed to quantify the frequency content of the signal received from said at least one sensor.

18. A gas turbine engine control system in accordance with claim 14 wherein to quantify the frequency content of the signal received from said at least one sensor, said EMU is further programmed to perform a Fourier analysis of the signal received from said at least one sensor.

19. A gas turbine engine control system in accordance with claim 14 wherein to detect oscillations of the rotor assembly, said EMU is further programmed to determine the amplitude of the modulation in speed using an analog frequency-to-voltage converter.

20. A gas turbine engine control system in accordance with claim 14 wherein to detect oscillations of the rotor assembly, said EMU is further programmed to determine the amplitude of the modulation in speed using a band pass filter.
